(19) United States
(12) Patent Application Publication
(10) Pub. No.: US 2010/0274777 A1
(43) Pub. Date: Oct. 28, 2010

(54) Method and System for Processing a Variable Click Domain Display

(76) Inventors: Danny Ho, Incline Village, NV (US); Joseph Wang, Burbank, CA (US)

Correspondence Address: ELMAN TECHNOLOGY LAW, P.C., P. O. BOX 209, SWARTHMORE, PA, 19081, US

(21) Appl. No.: 12/768,914

(22) Filed: Apr. 28, 2010

Related U.S. Application Data
(60) Provisional application No. 61/173,517, filed on Apr. 28, 2009.

(51) Int. Cl. G06F 17/30; G06Q 30/00

(52) U.S. Cl. 707/707; 707/723; 705/14.49; 707/E17.108

(57) ABSTRACT

Methods and systems for displaying at least one web site or promotion to a user (consumer) responsive to the user's query, on the user's browser, provide a display, that is for example, bifurcated, for the selected results web sites. A first, and typically larger portion of the display, takes up the balance of the display area, and is reserved for review and browsing of an operable web site, corresponding to the web site or promotion either initially displayed or most recently selected in the navigation area (navigation) of the computer screen, monitor or other display. A second portion of the display shows another portion of the navigation area (navigation) permitting the consumer to browse additional web sites or promotional options selected by the system server and/or computer.

### CROSS-REFERENCES TO RELATED APPLICATIONS

This application is related to and claims priority from commonly owned U.S. Provisional Patent Application Ser. No. 61/173,517, entitled: Method, System and Process for a Variable Click Domain Display, filed on Apr. 28, 2009, the disclosure of which is incorporated by reference herein.

### TECHNICAL FIELD

The present disclosed subject matter is directed to displaying web sites and web pages of search results.

### BACKGROUND

Consumers are constantly searching the Internet for goods, services and the like. One typical search begins when the user inputs (enters) a domain name into an address box of a browser, which is not owned by a retail business or which is mis-typed, the consumer's browser is directed to a landing page displaying text-based advertiser listings relevant to the consumer's input. For example, a consumer may wish to purchase a blue pen, and instead of going to a search engine or thinking about who might make or sell pens, simply enters the domain www.bluepens.com into the address box of their Internet browser.

It may be that makers or retailers of blue pens have not purchased the domain “bluepens.com.” However, there may be a person or entity who purchased the domain, bluepens.com, knowing that consumers would enter the domain in search of purchasing blue pens. This domain owner would construct a web page containing listings of various retailers or advertisers of pens, including perhaps pen accessories such as ink, paper, etc. The listings also serve as links, that when “clicked on” or activated by a mouse or other pointing device, redirect the consumer's browser to the retailer's or advertisers designated web site. This web page serves as a landing page, for the consumers who entered the domain www.bluepens.com, and whose browser has now been directed to this web page as a result of the domain entry. From this landing page, when a link (via a listing) is activated, or “clicked on” by a mouse or other pointing device, the consumer's browser is redirected to a web site determined by the advertiser associated with the activated link.

The advantage of this implementation is that a consumer may search multiple retailers' or advertisers' listings and select the one which appears most relevant or interesting. The retailer or advertiser will be charged when the retailer's or advertiser's listing is clicked on by the consumer, activating the link for browser redirection to the web site associated with the listing and link.

Unfortunately, this method of displaying a landing page full of listings is often rejected by consumers, for at least three reasons. First, the retailer or advertiser listings may not correspond to the domain or term entered by the consumer. This is because the landing page owner may not be able to fill the available display “real estate” with relevant links to blue pens. As a result, the landing page owner will fill the available display with other listings, unrelated to pens, ink, paper, etc., as opposed to leaving the space empty. This is because an empty space guarantees no clicks from the consumer and accordingly, no revenue for the landing page owner; the owner may reason a slim chance of a click-through from an irrelevant listing is still better than no chance from failure to list any advertisement whatsoever.

Second, the landing page owner may not have the incentive or resources to make the landing page visually appealing and appear professional. Industry experience reflects that the production effort put into creating such landing pages tends to be inferior to bona fide retail and similar web sites.

Finally, the landing page may present the consumer with a “search-like” experience or look and feel. In contrast, the consumer is likely to have a different set of expectations; namely, the consumer is likely to expect to find the homepage of a web site, which is why they entered the term(s) into the address box of their Internet browser, rather than the search box of a web page, of which they are browsing. Depending on implementation, anywhere between 60%-90% of consumers who see a landing page fail to reach an advertiser web site.

An alternative search method directs the consumer's browser directly to an advertiser's web site relevant to the consumer's input into the browser, thus bypassing the landing page full of listings. In this implementation, a remote computer chooses an advertiser, by formula or algorithm, which best matches the consumer's domain or keyword typed into the browser's address box. For example, a consumer who wishes to visit “Widgets.com” may mistype the domain in the address box of their Internet browser as “Wigets.com”, but nevertheless be directed to Widgets.com or a direct competitor of Widgets.com, depending upon which advertiser has a relationship with the owner of the domain name “Wigets.com.” The advertiser is charged for every visitor brought to the advertiser's web site (although perhaps at a reduced rate since the consumer did not explicitly click on the advertiser's listing).

This method of sending the consumer directly to an advertiser's web site potentially ensures a higher quality experience for the consumer, as compared to the search method where the consumer enters a term or terms into an Internet browser's address box. Further, the web site to which the consumer is delivered is generally of high aesthetic quality. However, if the wrong advertiser is chosen, the implementation will be unsatisfactory for the advertiser, who is paying for each visit and the consumers, whose browsers are directed to such an advertiser.

### SUMMARY

This document references terms that are used consistently or interchangeably herein. These terms, including variations thereof, are as follows.

The term “click”, “clicks”, “click on”, “clicks on” involves the activation of a computer pointing apparatus, such as a device commonly known as a mouse, on a location on a computer screen (monitor) or computer screen display, for example, an activatable portion or link, that causes an action of the various software and or hardware supporting the computer screen display.

A “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, that is accessible on the Internet.

A server is typically a remote computer or remote computer system, or computer program therein, that is accessible over a communications medium, such as the Internet, that provides services to other computer programs (and their users), in the same or other computers.

Pay Per Click (PPC), also known as price per click and cost per click, as used herein, is the amount of money that an advertiser, web site promoter, or other party who owns or is associated with a web site, will pay to a system administrator for providing their advertisement, listing, link or the like to a user, and the user clicks their mouse or pointing device on the advertisement, listing, link or the like, such that the user's browser is directed to the targeted web site associated with the advertiser, web site promoter, or other party who owns or is associated with the targeted web site.

A “client” is an application that runs on a computer, workstation or the like and relies on a server to perform some operations, such as sending and receiving e-mail.

“n” and “nth” in the description below and the drawing figures represents the last member of a series or sequence.

Click-through” or “click-throughs” are industry standard terms for a user clicking on a link or other activatable component (for example, activatable elements detailed below), or portion in an electronic object, such as a web page, web site, navigation, or other component displayed by the user's browser, and ultimately having the user's browser directed to the targeted data object, typically a web site, associated with the link or other activatable component.

The disclosed subject matter includes methods and systems for displaying at least one web site or promotion to a user (consumer) responsive to the user's query, on the user's browser (of his computer), by providing a display (viewable on the user's computer), which is, for example, bifurcated, for accommodating the selected results web sites. A first, and typically larger portion of the display, takes up the balance of the display area, and is reserved for review and browsing of an operable web site, corresponding to the web site or promotion either initially displayed or most recently selected in the navigation area (navigation) of the computer screen, monitor or other display. A second portion of the display shows another portion of the navigation area (navigation) permitting the consumer to browse additional web sites or promotional options selected by the system server and/or computer.

The disclosed subject matter is directed to methods and systems for displaying, in a data object, such as a display, web page or the like, at least one web site or promotion to a user or consumer interested in a category, concept, keyword or topic, based upon a query, for example, a domain or term(s), which they entered into the address box or search box of their Internet web browser, for example, a search box on a web page of a publisher's web site. The domain or term entered by the consumer may be a guess by the consumer about the name of an existing web site, promotion or other search term. Additionally, the query word(s) or term(s) may be properly spelled or unintentionally misspelled. The entered query is interpreted by a server and/or computer of the system, which matches or correlates the domain or term, by algorithm or formula, to a relevant search term, such as a category, concept, keyword, or topic. The system server and/or computer then selects one or more web sites or promotions which have been predetermined to have relevance to the matched or correlated search term.

The disclosed system and methods (processes) are such that the consumer's browser shows an unevenly bifurcated display, when displaying the selected results web sites. The smaller portion of the display (it may be a top or bottom bar, or a sidebar on the left or right sides of the display), shows a navigation area (navigation) permitting the consumer to browse the web site or promotional option(s) selected by the system server and/or computer. These web site options are shown in visual and textual form. The larger portion of the display, taking up the remaining balance of the display area, is reserved for review and browsing of a web site, corresponding to the web site or promotion most recently selected in the navigation area (navigation) of the computer screen, monitor or other display. The initial state of the larger web site display area will be a pre-selected web site, as determined by formula or algorithm, by the system server and/or computer. Whenever a consumer clicks on a web site option displayed in the navigation bar area of the display, a new web site replaces the current web site in the larger, remaining portion of the display area. The navigation area (navigation) is always available while the consumer is browsing the larger web site display area, and serves as an aid in sampling or gathering data to more accurately serve relevant web sites to the consumer and properly price the consumer's (user's) page views for the advertiser.

The disclosed system and methods (processes) improves the contemporary art by unifying disparate conventional methods in the Internet advertising industry to display relevant promotions to consumers who have typed a word or phrase into an Internet browser's address box or search box. That word or phrase may or may not exist as literally entered by the consumer.

The disclosed system and methods (processes) expands contemporary searching by responding to a consumer-entered domain, by causing the consumer's browser to display a bifurcated screen.

The disclosed system and methods (processes) employs algorithms, rules and policies to determine pricing and charging. It incorporates fraud detection technology and procedures, to ensure that the web site owner is not charged where there is reason to believe the click did not arise from a bona-fide consumer, user or source. For example, where the click to the same web site originates from the same IP address within too short a span of time, the advertiser is not charged for subsequent clicks from the Internet Protocol (IP) address.

The disclosed system and methods (processes) is such that the price an advertiser is charged for each click may also vary, depending upon the value of the click delivered. Click value is determined by statistics taken from historical data, including conversion rates for advertisers for traffic on the same or similar web sites.

Further, the price charged to an advertiser may vary depending upon the number of other advertisers visited by the consumer, through clicking on various advertiser web sites available in the navigation bar. The disclosed subject matter adjusts the price charged to each advertiser, to ensure that the price is commensurate with the value of the consumer click delivered to the advertiser.

An embodiment of the disclosed subject matter is directed to a method for providing search results over a communications network to a computer of a user, the computer of the user is linked to the communications network. The method comprises: 1. receiving, by a system computer device, for example, a server or servers of the system, linked to the communications network, a query from a source computer device, for example, a publisher server to which the browsing application (browser) of the computer of the user has been directed, with the source computer device linked to the communications network, the source computer device in electronic communication with the browsing application of the computer of the user; and, 2. providing a plurality of results, for example, listings corresponding to web sites of one or more web pages, in response to receiving the query in a display, by the system computer device, to the browsing application, a first portion of the display for accommodating one result as an operable web site (comprising one or more web pages), and, a second portion of the display for accommodating at least one other result as a representation of a web site (comprising one or more web pages).

Another embodiment is directed to a system for providing search results. The system includes, for example, one or more servers, associated with numerous components modules and the like. The system comprises a first computer component configured for receiving a query, a second computer component configured for providing a providing a plurality of results responsive to the query, and a third computer component configured for providing at least one template for accommodating the plurality of results and building out the template with the results for display in association with the browsing application of the computer of the user associated with the query. The template includes a first portion and a second portion, which when built out, the first portion accommodates one result as an operable web site (comprising one or more web pages), and, the second portion accommodates at least one other result as a representation of a web site (comprising one or more web pages) including an activatable element. The activatable element is such that when activated, the web site corresponding to the activatable element replaces the currently operable web site as the operable web site in the first portion of the display.

Another embodiment is directed to a computer-usable storage medium having a computer program embodied thereon for causing a suitably programmed system to provide a display of a plurality of results in response to a query from the computer of a user, over a communications network, to the browsing application of the computer of the user, by performing the following steps when such program is executed on the system. The steps include receiving a query from the computer of the user over the communications network, the computer of the user including a browsing application, and providing a plurality of results in response to receiving the query in a display, to the browsing application over the communications network. A first portion of the display is for accommodating one result as an operable web site (comprising one or more web pages), and, a second portion of the display is for accommodating at least one other result as a representation of a web site (comprising one or more web pages). The representation includes an activatable element, which when activated, provides access to the corresponding web site for its placement into the first portion of the display.

Throughout this document, there may be textual and graphical references made to trademarks. These references to the trademarks are unintentional and the trademarks are the property of their respective owners, and are referenced only for explanation purposes herein.

### BRIEF DESCRIPTION OF THE DRAWINGS

Attention is now directed to the drawing figures, where like or corresponding numerals or characters indicate corresponding or like components. In the drawings:

FIG. 1 is a diagram of an exemplary system supporting and performing the disclosed subject matter, in an exemplary environment;

FIGS. 2A to 2C are diagrams of the databases of FIG. 1;

FIGS. 3A, 3B and 3C form a flow diagram (flow chart) detailing an exemplary process performed in accordance with the disclosed subject matter;

FIGS. 4A and 4B are screen shots of web pages of the web site of a publisher affiliated with the exemplary system;

FIG. 5A is a diagram of an exemplary template for the exemplary system;

FIG. 5B is a diagram of an element of FIG. 5A;

FIG. 5C is a diagram of a master web page from the template of FIGS. 5A and 5B, as ordered by a browsing application;

FIGS. 6A to 6C are diagrams of master web pages from the build out of the template of FIGS. 5A and 5B, as well as an example operation of the master web page; and,

FIG. 7 is a diagram of an alternate master web page from the build out of the template of FIGS. 5A and 5B.

### DETAILED DESCRIPTION OF THE DRAWINGS

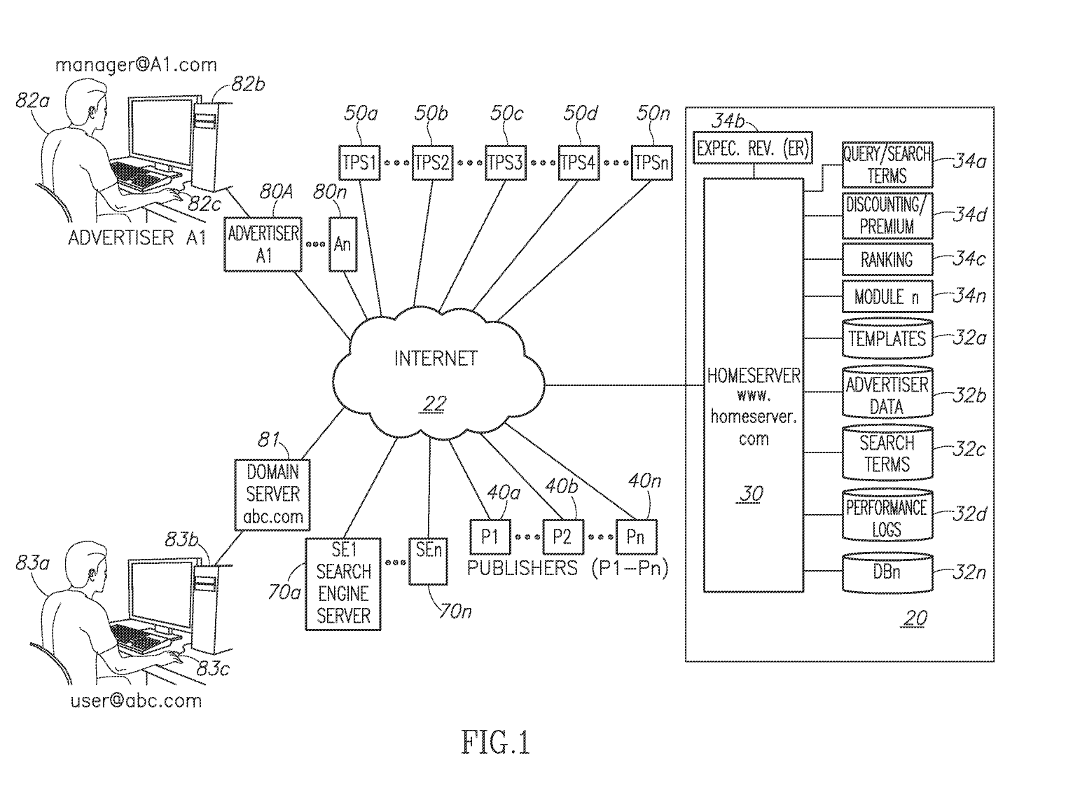

FIG. 1 shows the present disclosed subject matter in an exemplary operation. The present disclosed subject matter employs a system 20, formed of one or more computer devices, such as servers, computer components and the like, that are linked to a communications network, such as a wide area network (WAN), that may be, for example, the Internet 22. The system 20 includes a home server (HS) 30, for performing the processes of the disclosed subject matter. The system 20, via the home server 30, is linked, directly or indirectly, to an endless number of servers, computers, computerized components and the like, for operating with the system 20, over the communications network, e.g., the Internet 22.

Throughout this document, the linking of the computer devices, such as servers, computers, components, and the like, to the communications network, e.g., the Internet 22, may be by wired or wireless links, or combinations thereof. When the aforementioned computer devices are linked or mapped to each other, either via the communications network, e.g, the internet 22 or locally, they may be in electronic communication with each other, data communication with each other, or both.

For example, some of the servers and other computer components linked to the communications network, e.g., the Internet 22, include publisher servers (P1-Pn) 40a-40n, the publishers typically being affiliates of the system 20, Third Party Servers (TPS1-TPSn) 50a-50n, one or more search engine servers, represented by search engine servers 70a-70n, and domain servers 80a-80n and 81. The domain servers 80a-80n are for advertiser domains, and there is a domain server with the URL www.abc.com, representative of numerous other domain servers. Through the respective domain servers 80a-80n and 81, the advertiser 82a, user 83a (representative of multiple users) and enterprises, link (directly or indirectly) to the communications network, e.g., the Internet 22, and ultimately to the servers and components linked thereto.

The system 20 includes a home server (HS) 30, a computer device formed of one or more components, and may include internal and external storage media. The home server 30 is of an architecture that includes one or more components, modules and the like, for providing numerous additional server functions and operations, including, for example, comparison and matching functions, policy and/or rules processing, data transmission and receiving, electronic mail (e-mail) operations, various search and other operational engines, browser directing and redirecting functions, and the like. The home server 30 is accessible by a system administrator either over a local communications network fro the system 20, for example, a local area network (LAN), or over the communications network, e.g., the Internet 22.

The home server 30 includes various processors, including microprocessors, for performing the server functions and operations detailed herein, including those for generating and supporting HTML documents and its associated data, such as java script and the like, for administering, query handling, selecting, delivering, displaying, changing and accounting for various information, including advertisements, for example, in the form of web pages and web sites, browser redirection, and monitoring time on a web site or web page as well as hardware and software for analyzing the recorded time, as well as for detecting invalid or fraudulent clicks based on their positioning inside browser windows.

The systems and methods disclosed herein can be configured for monitoring time on a web site or web page as well as employing hardware and software for analyzing the recorded time, as well as for detecting invalid or fraudulent clicks based on their positioning inside browser windows, as disclosed, for example, in commonly owned U.S. patent application Ser. No. 11/844,983 (U.S. Patent Application Publication No. US 2008/0052629 A1), entitled: Methods and Systems for Monitoring Time on a Web Site and Detecting Click Validity, the disclosure of this patent application is incorporated by reference herein.

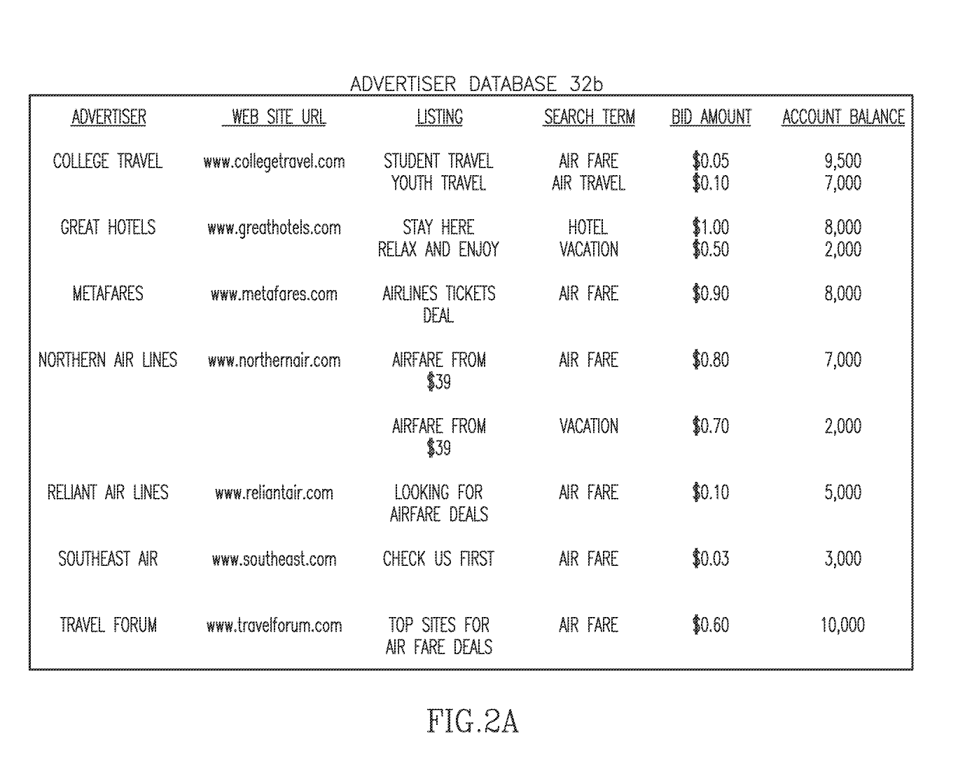

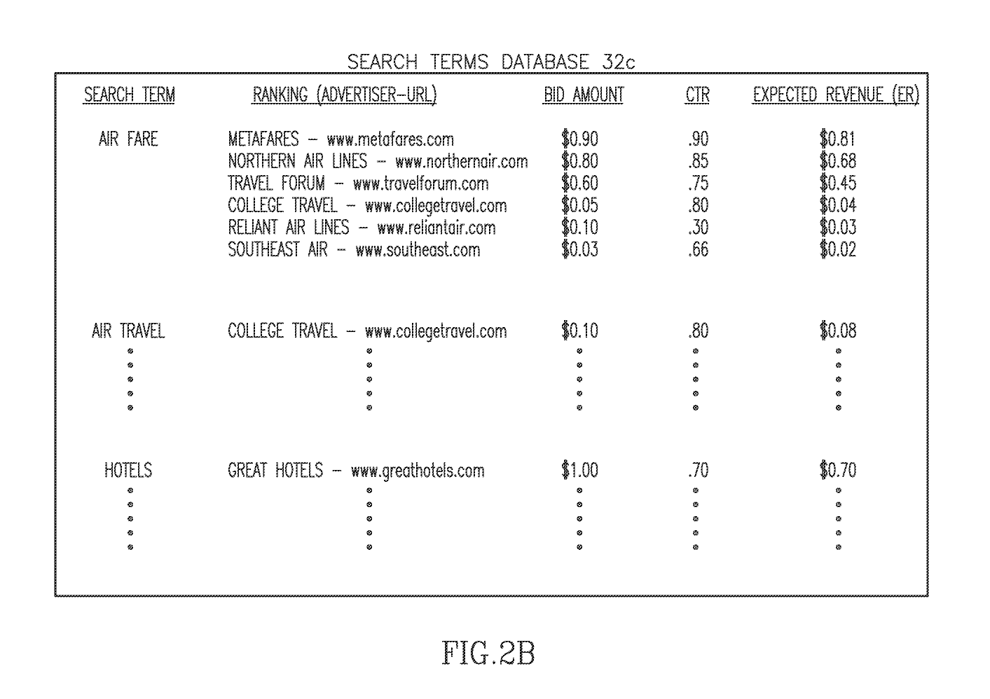

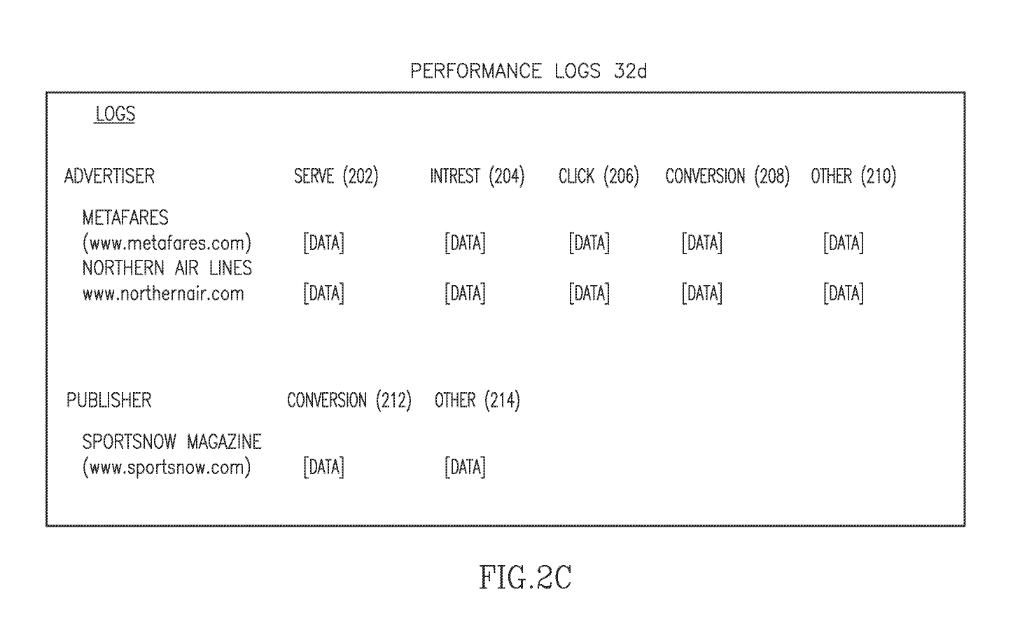

The home server 30 includes numerous databases 32a-32n, some of which are shown in detail in FIGS. 2A-2C, and modules 34a-34n for performing the processes of the disclosed subject matter. The databases, for example, include those for templates 32a, advertiser data 32b (FIG. 2A), search terms 32c (FIG. 2B, including present ranking based on expected revenue), performance logs 32d (including a Serve Log 202, Click Log 206, Conversion Log 208/212, and Interest Log 204, as well as other logs 210/214 for advertisers and/or publishers, as shown, for example, in the database of FIG. 2C), and various other databases, caches and the like, represented by database/cache 32n. In FIGS. 2A, 2B and 2C, the data entered in each of the logs is represented by “[DATA].”

The modules, for example, include those for matching or correlating queries with search terms 34a, search terms including, for example, keywords, concepts, categories, expected revenue 34b, ranking 34c, for ranking results, information providers, advertisers, etc., determining PPC premiums, discounts or remaining the same 34d, and additional modules, represented by module 34n.

The home server 30 may also include storage media, devices, etc, either internal or associated therewith. This storage media may store documents and/or data corresponding to these documents, such as hypertext markup language (HTML) coded documents (and/or data corresponding thereto), that are sent by the home server 30 (for example, as HTML coded documents), detailed below. By “home server”, it is meant all servers and components necessary to support the home server 30 in the requisite function.

The home server 30 also includes or is operated in conjunction with linked imaging servers, as disclosed in commonly owned U.S. patent application Ser. No. 10/915,975 (U.S. Patent Application Publication No. 2005/0038861 A1), entitled: Method and System for Dynamically Generating Electronic Communications, Ser. No. 11/361,480 (U.S. Patent Application Publication No. 2006/0212349 A1), entitled: Method and System for Delivering Targeted Banner Electronic Communications, and, Ser. No. 11/774,106 (U.S. Patent Application Publication No. 2008/0098075 A1), entitled: Method And System For Providing Electronic Communications With Dynamically Provided Content To Third Party Mail Transfer Agents, the disclosures of all three of these patent applications are incorporated by reference herein. The home server 30 also includes or is associated with caches, databases and the like, as disclosed in U.S. patent application Ser. Nos. 10/915,975, 11/361,480 and 11/774,106. For explanation purposes, the home server 30 has a uniform resource locator (URL) of, for example, www.homeserver.com.

There may also be one or more publisher servers (P1-Pn) 40a-40n. These publisher servers 40a-40n are, for example, associated with and controlled by a third party, but are affiliated with the system 20, such that queries and data received from each publisher server 40a-40n map back from the home server 30 to the requisite publisher server 40a-40n. Each publisher server 40a-40n is typically controlled by an entity separate from, and unrelated to, the entity that controls the home server (HS) 30 and/or any of the other servers, components and the like linked to the communications network, e.g., the Internet 22, directly or indirectly.

The publisher servers 40a-40n include various processors, including microprocessors, for performing the aforementioned server functions and operations and storage media, either internal or associated therewith, as well as other server operations. By “publisher server” here, it is meant all servers and components necessary to support the publisher servers 40a-40n, such as proxy servers, caches, databases, etc., in the requisite function.

Other servers linked to the communications network, e.g., the Internet 22, include third party servers (TPS1-TPSn) 50a-50n. These Third Party Servers 50a-50n can host web sites for the various information providers and advertisers. These servers are, for example, controlled by information providers, advertisers, web site promoters, including publishers, content providers, or other entitles, that may or may not be related to any of the entities detailed above, in particular, the entity associated with the system 20 and home server 30.

The search engine servers 70a-70n are linked to the communications network, e.g., the internet 22. These servers 70a-70n send entered user queries to the home server 30, as they are mapped to the system 20/home server 30. Example search engines are those such as Yahoo.com, bing.com, Miva.com, and, Ask.com.

Domain servers 80a-80n, 81, are representative of any domain server that may be linked to the communications network, e.g., the Internet 22. For example, domain servers are shown for information providers or advertisers (A1-An) 80a-80n, for example, for the domain “A1.com,” and for an Internet user 83a, the domain server 81 with the URL “abc.com.” For example, e-mail addresses for users 82a, 83a associated with the domain server A1 is manager@A1.com and user@abc.com, respectively. The computers 82b, 83b of these users 82a, 83a are linked to the respective domain servers 80a, 81. The users 82a, 83a are exemplary of all users linked to the communication network, e.g., the Internet 22.

Advertiser users 82a, such a the user identified as manager@A1.com can communicate with the system 20 and home server 30, to create, manage and update his particular advertiser account, listing, URL and other data with the system 20, in the various databases of the home server 30. Accordingly, the advertiser user 82a is representative of all advertiser users associated with the system 20. Internet user 83a can electronically communicate with the publishers 40a-40n, as well as other servers along the communications network, e.g., the Internet 22, as detailed further below.

For example, each user 82a, 83a, exemplary of all users, has a computer 82b, 83b (such as a multimedia personal computer with a Pentium® central processing unit (CPU), that employs a Windows® operating system), that uses an e-mail client installed thereon (that provides each user 82a, 83a with a unique address and the ability to utilize one or more e-mail addresses), and also includes a web browser, browsing software, application, or the like, to access web sites or web pages from various servers and the like, and for example, the home server 30 and third party servers 50a-50n, on the Internet 22. Some exemplary web browsers/web browsing software include, Internet Explorer®, from Microsoft, Redmond, Wash., Netscape® Navigator®, and Safari®. The computers 82b, 83b are linked to the Internet 22. The computers 82b, 83b may also be operated by an activatable pointer, such as a mouse 82c, 83c or the like, and include a monitor or screen 82d, 83d (“monitor” and “screen” of a computer used interchangeably herein).

While various servers, computer components and the like, have been listed, this is exemplary only, as the present disclosed subject matter can be performed on an endless numbers of servers and associated components, which are in some way linked to a communications network, such as the Internet 22, either directly or indirectly.

Additionally, all of the aforementioned servers include components for accommodating various server functions, in hardware, software, or combinations thereof, and typically include storage media, either therein or associated therewith. Also in this document, the aforementioned servers, storage media, and components can be linked to each other or to the communications network, such as the Internet 22, either directly or indirectly.

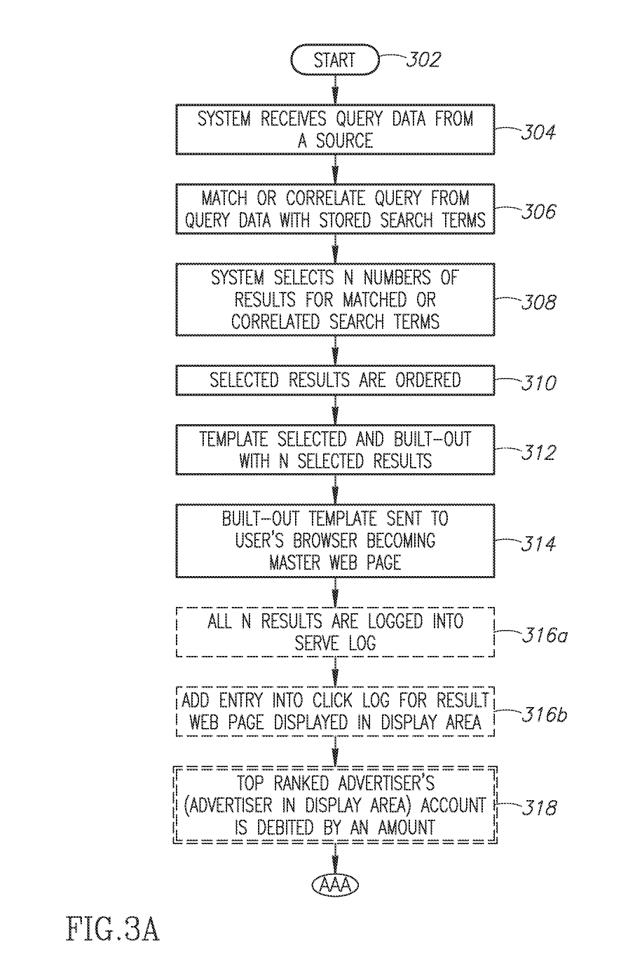

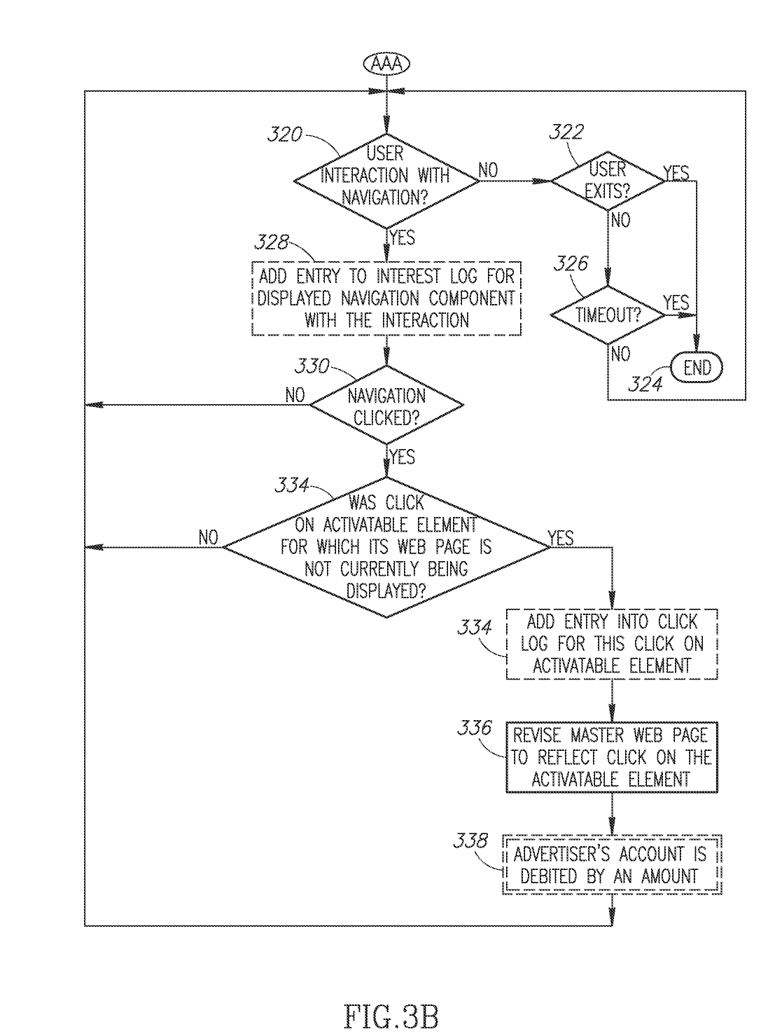

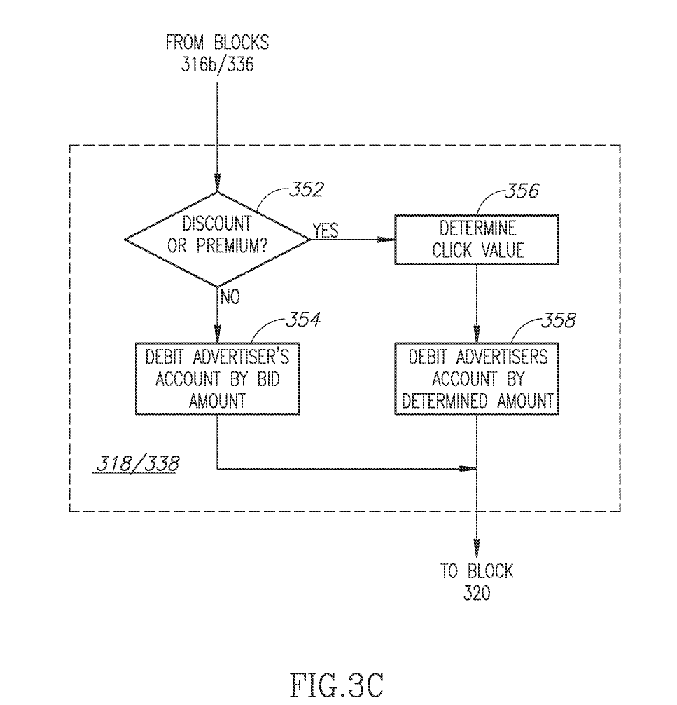

Attention is now directed to the flow diagram (flow chart) of FIGS. 3A-3C, which details an exemplary process in accordance with the disclosed subject matter. Attention is also directed to FIGS. 2A-2C, 4A-6C, 7, to illustrate various aspects of the process of FIGS. 3A-3C. In the flow diagram, the order in which the steps of the process are performed is exemplary, and alternate orders are permissible. Additionally, steps shown in broken line blocks, and double broken line blocks are optional, and any one or all of these optional steps may be bypassed, as these optional steps and do not need to be performed in order to complete the disclosed process.

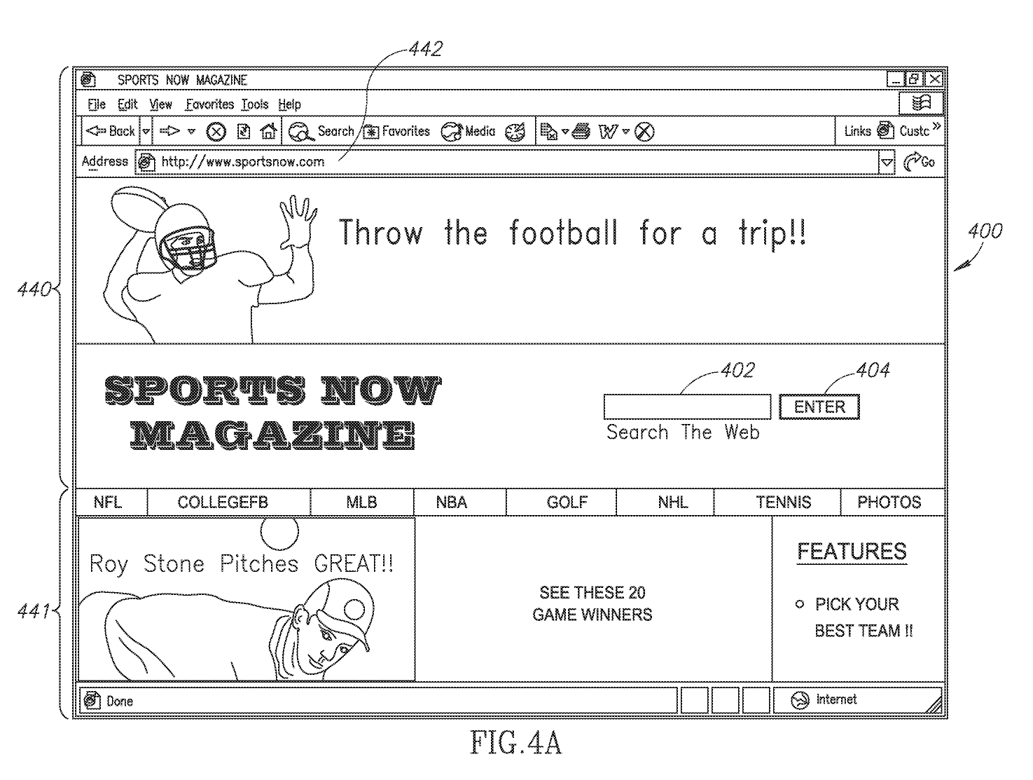

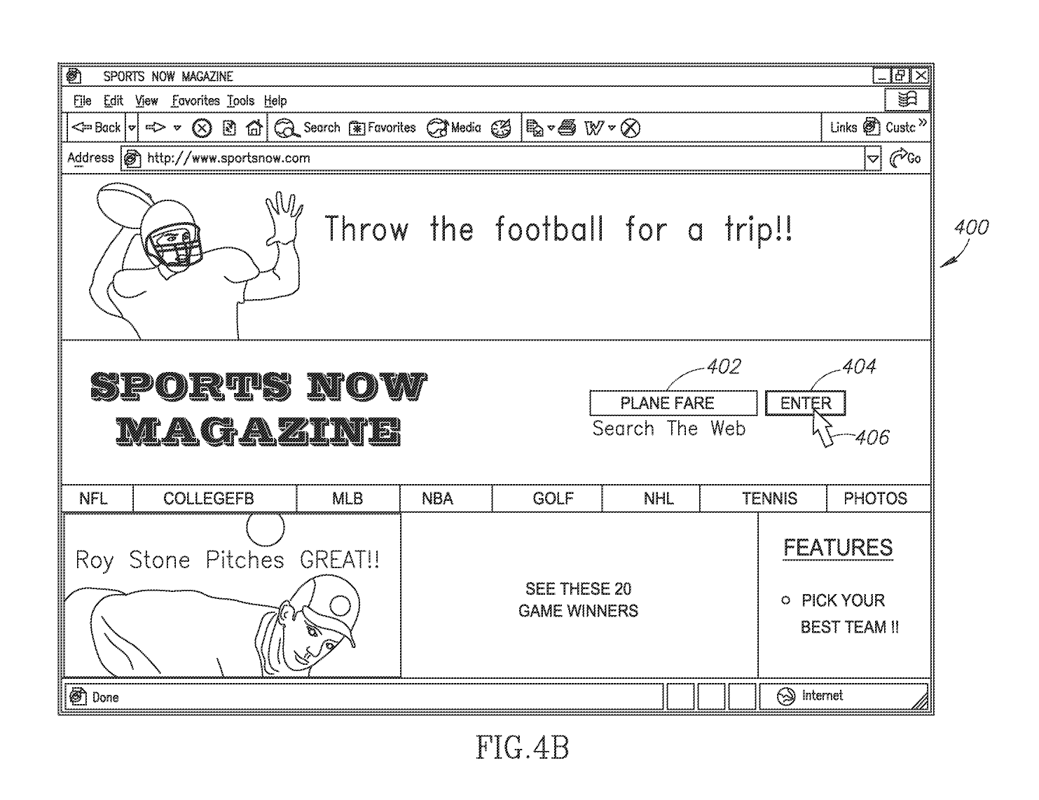

Prior to the start 302 of the process of FIGS. 3A-3C, an exemplary user, for example the user 83a is browsing the web page 400 of the web site of publisher P1, the web site hosted on publisher P1's server 40a, as shown in the screen shot of FIG. 4A. The web site of publisher P1 is Sports Now Magazine, with the URL www.sportsnow.com. The web page 400 includes a query box 402 and an activation button 404, that when activated, directs the query to the system 20 and the home server 30, over the communications network, e.g., the Internet 22. The web page 400 also includes a frame bar 440, a body 441 and a browser address bar 442. Additionally, for example, the publisher P1, e.g., Sports Now Magazine, is an affiliate of the system 20, such that its web page 400 maps to the home server 30 of the system 20.

The user 83b then enters (i.e., inputs or types) a query into the query box 402, for example, “PLANE FARES,” and enters the query, shown by the arrow 406, representing a mouse click on the “enter” box 404, as shown in FIG. 4B. The query is sent to the system 20/home server 30 and the process resumes at block 304.

Alternately, the user 83a may attempt to enter a domain, for example, www.planefares.com, that may or may not exist. As the publisher page 400, via the publisher server 50a, maps to the system 20, as the publisher is an affiliate of the system, this query of a domain is treated like the query of the words “PLANE FARES.” Accordingly, the words “PLANE FARES” will be analyzed against stored search terms to determine the equivalent or correlated search term (at block 306). The system 20 receives this query, and the process resumes at block 304.

Alternately, the user 83a may enter a query into a query box of a web page of a search engine, the web page of the web site hosted by a search engine server, such as server 70a. This entered query is then sent to the home server 30, as the search engine server 70a is mapped to the home server 30. The process resumes at block 304.

At block 304, the system 20 receives the query in query data from a source, the source, for example, the publisher 40a, a search engine 70a, or any other location linked directly or indirectly to the communications network, e.g., the Internet 22. A connection or pipe between the source, for example, the user's computer 83a its associated browsing application (browser), and the home server 30 of the system 20 (over the communications network, e.g., the Internet 22) is now opened. The steps, including those indicated as optional, of blocks 304-338 and 352-358, are performed automatically over this connection or pipe.

The query from the received query data is now evaluated against stored search terms, by being matched or correlated to a stored search term (stored in database 32g of FIG. 2A), by the query/search term module 34a of the home server 30, with a search term selected, at block 306. This module 34a operates by first looking for an exact match of the query to its stored search terms, and if an exact match is not found, attempts to find the closest search term to the query, for a correlation, by one of many conventional algorithms for performing this function.

For example, for the query “Plane Fares,” the home server 30 does not have an exact match. However, it does have the search term “Air Fares” in its terms/advertiser bid database 32c (FIG. 2A), and the algorithm has determined the search term “Air Fares” to be sufficiently correlated to the user query “Plane Fares.” Accordingly, “Air Fares” is the search term selected by the system for this user query.

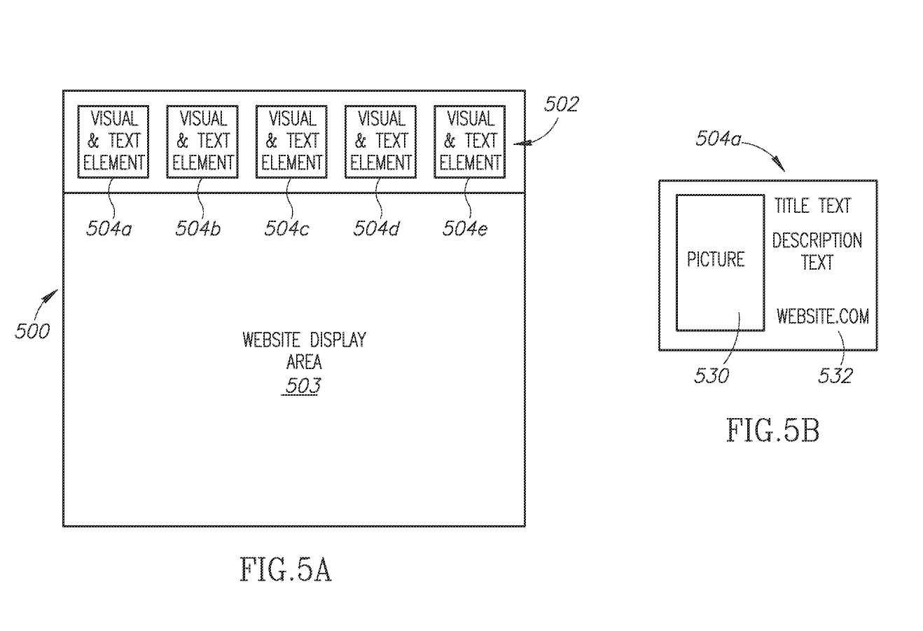

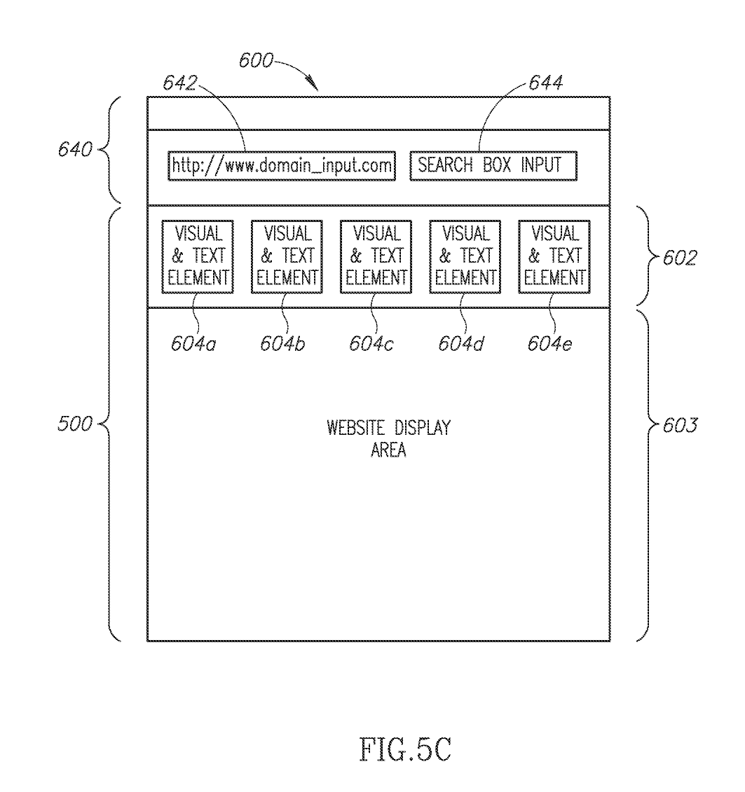

N number of results or listings are now selected for the selected search term, at block 308. The “N” is determined by the system 20. For example, the N number of results typically corresponds to the number of listings or results that a template, such as template 500 of FIGS. 5A and 5B, described in detail below, can accommodate. Accordingly, for example, the template 500 accommodates five advertisers, whereby N=5.

For example, the results or listings described may be, for example, those of advertisers, and an exemplary operation of the system 20 is disclosed using advertisers. However, the disclosed results or listings for the system 20 (and home server 30) operation, are not limited to advertisers, and may represent web pages, search pages, information, blogs and items, and articles of other information providers, as commonly found on communications networks. Additionally, for example, as N=5, five advertisers are selected by the system 20 (e.g., the home server 30), detailed below.

The N results or listings are ordered, at block 310. The ordering can in accordance with any ranking defined by the system 20, in particular, as performed by the ranking module 34c. Suitable ordering by rank may be ascending, descending, or random.

Returning to the example for advertisers, the ordering may be by bid amounts for the particular search term, or by any other acceptable order. One example order that may be used, is an order produced by the expected revenue module 34b of the home server 30, and is shown in the database of FIG. 2B. The expected revenue module 34a operates by numerous formulae, with an exemplary formula based on the bid amount multiplied by the click through rate (CTR) to determine the expected revenue (ER) for that particular advertiser. The CTR, for example, is a value based on the amount of clicks that an advertiser receives. For example, CTR can be calculated by the formula

CTR=#CLICKS/#SERVED,

where, # CLICKS is the number of clicks for an advertisement; and

# SERVED is the number of times the advertisement is served.

The CTR is used in determining the expected revenue. The expected revenue module 34b also applies any rules and policies in determining the expected revenue, and may determine not to select an advertiser for responding to a particular query, based on rules and policies for that advertiser, or any other advertiser in the data bases 32b, 32c.

Returning to the example operation for the system 20, the selected search term “Air Fares” has six advertisers with active bids on this search term, as shown in the data base of FIG. 2A. These six advertisers are (in alphabetical order but unranked): 1. College Travel (www.collegetravel.com); 2. Metafares (www.metafares.com); 3. Northern Air Lines (www.northernair.com); 4. Reliant Air Lines (www.reliantair.com); 5. Travel Forum (www.travelforum.com); and, 6. Southeast Air (www.southeast.com). The expected revenue module 34b has applied the CTR to each advertiser's bid, in accordance with the following example formula:

ER=Bid Amount×CTR

The expected revenue module 34b, coupled with the ranking module 34c, absent any limiting rules and policies for these six advertisers, has established five advertisers in the following ranked order, based on expected revenue, as shown in FIG. 2B: 1. Metafares (www.metafares.com), with ER=$0.81; 2. Northern Air Lines (www.northernair.com), with ER=$0.68; 3. Travel Forum (www.travelforum.com), with ER=$0.45; 4. College Travel (www.collegetravel.com), with ER=$0.04; and, 5. Reliant Air Lines (www.reliantair.com), with ER=$0.03.

A template is now selected from the Template database 32a and built out, at block 312. An example template 500, suitable for accommodating five (N=5) results is shown in FIG. 5A. The template 500 includes a navigation bar 502 and web site display area 503. The navigation bar 502 includes elements 504a-504e, for example, five elements (N=5). Each of the elements 504a-504e accommodates one of the five results, as each element 504a-504e receives and support listings (for example, in element 504a), such as visual 530 and text 532 in FIG. 5B, from each of the selected results, as well as links to the home server 30. Each of the elements 504a-504e, for example, can serve as a representation of a web page corresponding to the result or listing. For example, the selected (N=5) advertisers, e.g., their listings and links to the home server 30, as well as associated data, are loaded into the respective elements 504a-504e of the template 500.

The links underlie the listing of each element, such that the elements 504a-504e are activatable elements when the template 500 is built out as the web page 600 (FIG. 5C). The web site display area 503 accommodates the web page of the selected element, and maps to the home server 30 for data transmissions, and to the server that hosts the web page (for example third party servers TPS1-TPSn 50a-50n and/or advertiser servers A1-An 80a-80n), allowing for the user to interact with the web page and the entity, for example, the advertiser associated therewith.

At block 314, the now-built out template 500 of FIG. 5A is sent to the browsing application of the computer of the user who entered the query. The template 500 couples to the web page frame bar 640, forming a data object, such as a master web page 600, shown in FIG. 5C. When in the browser, the master web page 600 serves as a display for web pages and activatable elements 604a-604e. The frame bar 640 includes a browser address bar 642, for the URL of the master web page 600. There is also a search bar 644, into which users enter queries, which when entered, are transmitted to the home server 30, for performing the process detailed herein. As the template 500 is now a web page, components labeled in the “500's” and described above for the template are now labeled in the corresponding “600's,” as they are now components of the master web page 600.

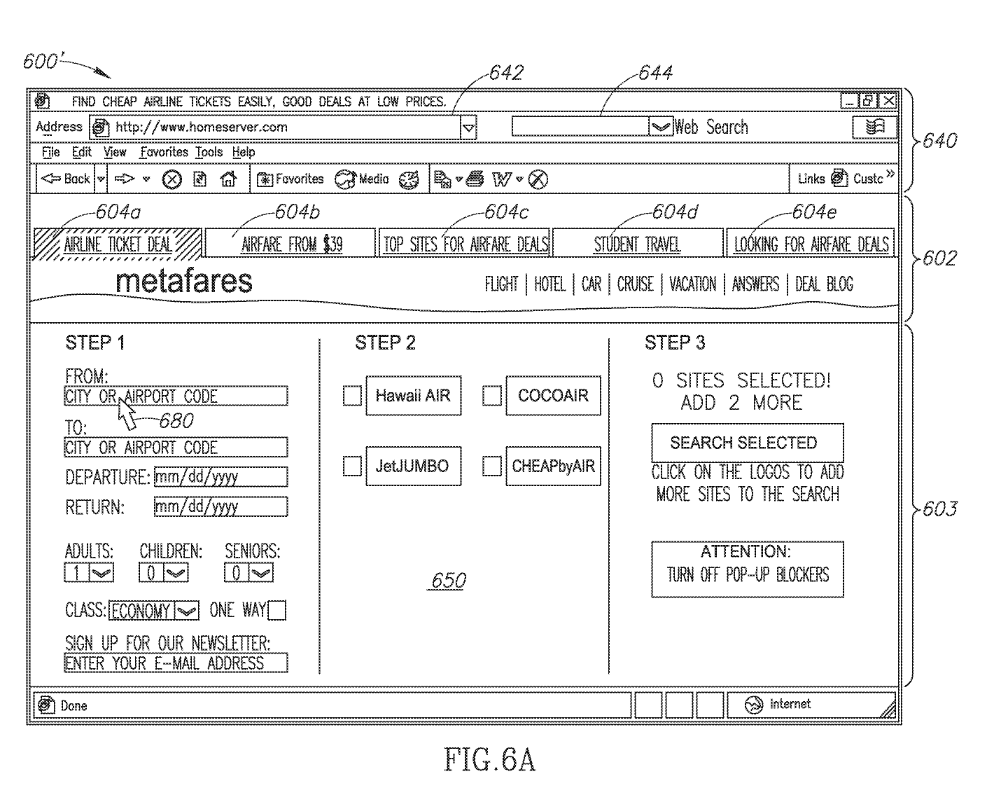

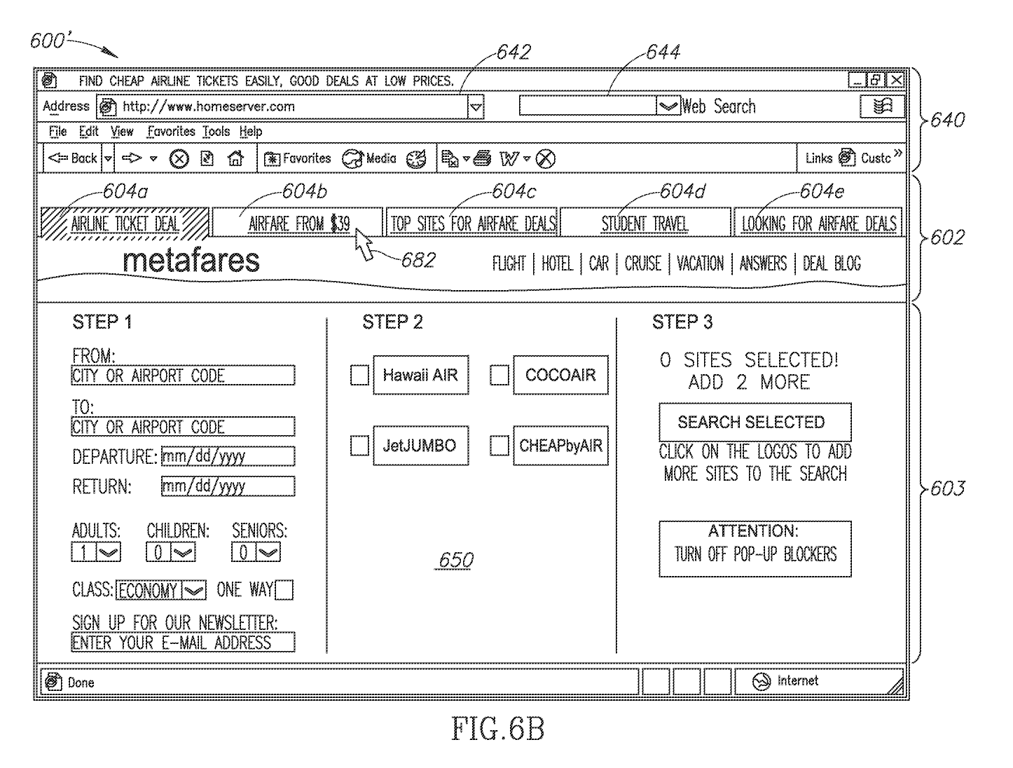

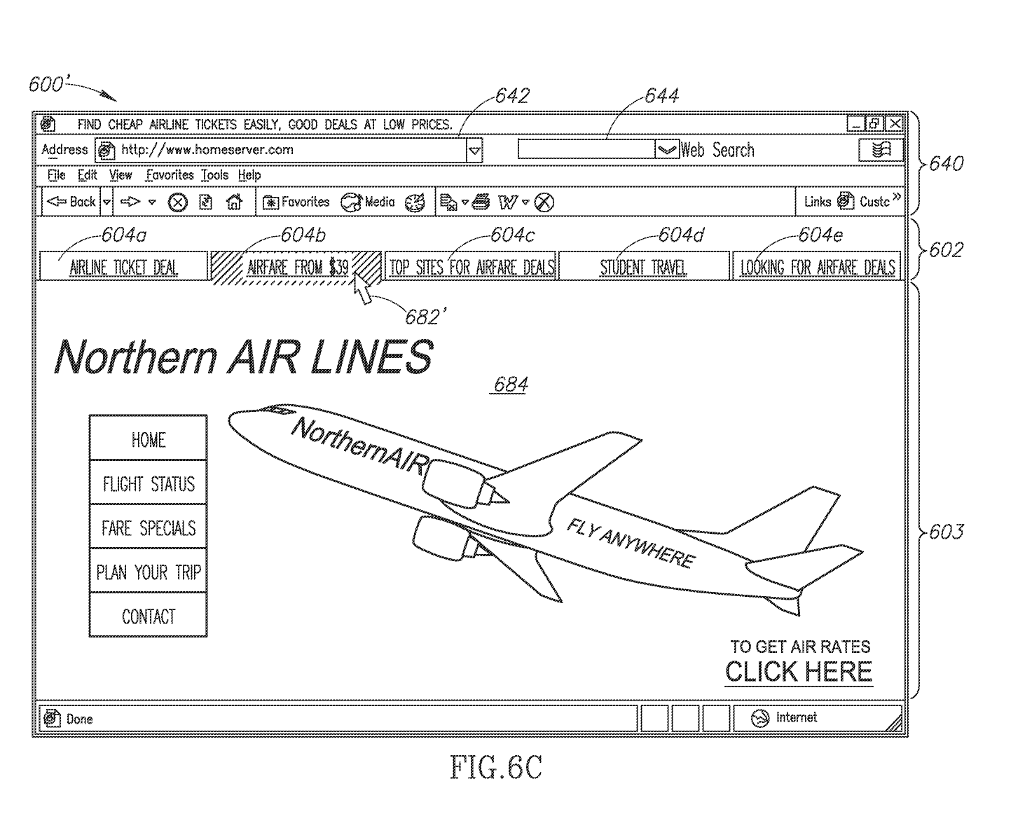

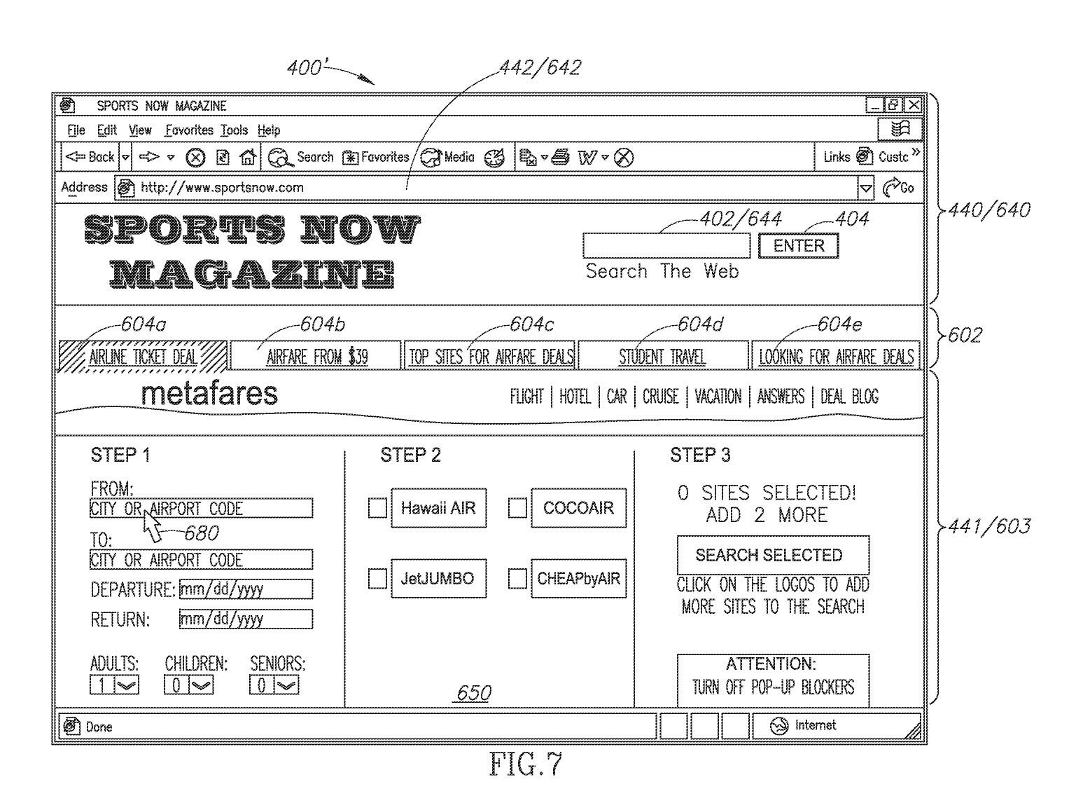

Exemplary master web pages 600′ (FIGS. 6A-6C), 400′ (FIG. 7) map to the home server 30. The home server 30 controls operations of the master web pages, e.g. master web pages 600′, 400′, as detailed further below. For example, master web page 600′ is from the home server 30, and the address bar 642 of the master web page 600′ is the URL www.homeserver.com. In another example, the master web page 400′ (FIG. 7) is that of the publisher, such that the address bar 442 is the URL www.sportsnow.com. The master web page 400′ of FIG. 7 includes components of the previous web page 400 as well as components of the web page 600, these components being described above and numbered the same. Other master web pages may be hosted by numerous other third parties, for example on third party servers TPS1-TPSn 50a-50n, search engine servers 70a-70n, provided they map back to the home server 30, for control as detailed below. All of these exemplary master web pages 600′, 400′ are formed in accordance with the master web page 600 of FIG. 5C.

Turning to FIG. 6A, the example master web page 600′, which has been created, is hosted by the home server 30, and carries the URL www.homeserver.com in the browser address bar 642. The master web page 600′ includes a navigation, formed of the web site display area 603 and the activatable elements 604a-604e. This navigation is mapped to the home server 30, with operations of the navigation discussed below. Each of the results, for example, the five selected advertisers, includes a listing, that is shown on each activatable element 604a-604e (as well as in the database of FIG. 2A for the search term “Air Fares”). For example, each activatable element may be representative of a target web site corresponding to the listing (or result). Each listing is coupled with an underlying link, that when activated by a mouse click or other pointing device activation, sends data to the home server 30, to which the link from the corresponding activatable element 604a-604e is mapped.

The activatable elements 604a-604e are also responsive to mouse hovers, and when a mouse hover is detected on these elements 604a-604e (on any of the elements whose web site is not currently being displayed), additional information will appear. This additional information is, for example, a preview of the target web site, and appears or pops-up with one or more of, additional text, graphics and the target web site URL. The additional text or graphic is activatable, like the corresponding activatable element 604a-604e and a mouse or pointer click thereon, will activate the corresponding activatable element 604a-604e, as described immediately above and below.

The top ranked result, for example, the top ranked advertiser, metafares.com, has its web page 650 (FIG. 6A) placed into the display area 603 (of the master web page 600′), where it is the operable current web site. The display area 603 is formerly the display area 503, of the template 500.

This web page 650 maps to the home server 30 for navigation data (such as detections of mouse hovers over the web page, that are recorded in the interest log of the home server 30), and is linked (by electronic and data connections) to the target web site of the advertiser-provided URL, for example, as listed in the database of FIG. 2A for the respective advertiser (the target web site for each advertiser for example, as hosted by a third party server TPS1-TPSn 50a-50n or an advertiser server A1-An 80a-80n), should the user 83a desire further interaction with this web page 650 and its web site. The activatable element 604a, which includes the listing corresponding to the displayed web page 650 (e.g., for metafares.com), is highlighted and becomes part of the display area 603 of the master web page 600′, during the time this web page 650 (for Metafares.com), is in the display area 603 of the master web page 600′.

The remaining advertisers (the four advertisers whose web pages are not currently in the display area 603 of the master web page 600′ in FIG. 6A) have their listings on the remaining (non-highlighted in FIG. 6A) activatable elements 604b-604e. The activatable elements 604a-604e include links that map back to the home server 30, such that mouse hovers over and clicks on these activatable elements can be recorded in the home server 30 (in serve 202, interest 204, and click 206 logs respectively of FIG. 2C), and acted on by the home server 30. For example, in the master web page 600′ of FIG. 6A, the four remaining advertisers, as ranked by their expected revenues are: 1. Northern Air Lines (www.northernair.com), 2. Travel Forum (www.travelforum.com), 3. College Travel (www.collegetravel.com), and, 4. Reliant Air Lines (www.reliantair.com). These four advertisers occupy the activatable elements 604b-604e, from left to right, of FIGS. 6A-6C, and for example, the positions of these elements 604a-604e do not change during the display of the master web page 600′ and its associated navigation.

In an optional step, at block 316a, all N results are logged into a serve log (202 FIG. 2C) of the home server 30. For example, click log (206 FIG. 2C) entries would be made for advertisers, Metafares, Northern Air Lines, Travel Forum, College Travel and Reliant Air Lines.

In another optional step, at block 316b, an entry is added to the click log 206 of the home server 30, for the result initially displayed in the display area 603 of the master web page 600′, i.e., the top ranked result. For example, the top ranked advertiser, Metafares, whose web page 650 is initially in the display area 603 of the master web page 600′, has an entry made in the click log 206 of the home server 30.

In another optional step at block 318, where the N results are, for example, for advertisers, the advertiser whose web page is in the display area (for example, display area 603 in FIG. 6A) has its account (shown in the database of FIG. 2A) debited by an amount. This step of block 318 is shown in a double broken line box, as it is specific to Pay Per Click (PPC) advertising, such as is used by advertisers. This optional step is also performed at block 338.

It is now determined if the user is interacting with the navigation, at block 320. For example, it is determined if the user 83a, through his computer 83b and mouse 83c, is interacting with the display web page 650 or any of the elements 604a-604e. Such interactions include the user actively moving the mouse or pointing device over the display area 603 of the master web page 600′ (i.e., that holds web page 650 for metafares.com), or along the elements 604a-604e of the master web page 600′.

If the system 20, via the home server 30, can not detect any interaction with the navigation, the system 20 determines if the user has exited the navigation, at block 322. Exiting the navigation may be by a user logging off of the system 20, entering a new search into the search box 644 of the master web page 600′, or placing a new domain or other term into the browser address bar 642 of the master web page 600′.

If the user has exited, the process moves to block 324, where it ends. If the user has not exited, the process moves to block 326, where it is determined if the master web page 600 has timed out, as programmed by the system 20, at block 326. If there is a timeout, the process moves to block 324, where it ends. Otherwise, absent a timeout, the process returns to block 320 and continues as described above.

Returning to block 320, if there is user interaction with the navigation, an entry is added to the interest log (204 FIG. 2C) of the home server 30 for the web page displayed or element, which received the mouse hover during the interaction with the navigation, an optional process, at block 328. For example, if the arrow 680 of FIG. 6A is a mouse hover, this hover is user interaction with the navigation, and an entry is made in the interest log 204 for the advertiser, e.g., metafares.

The process moves to block 330, where it is determined if the navigation, display area 603 (including displayed element 604a, considered part of the display area while merged into the display area 603), or non-displayed activatable elements 604b-604e, have been clicked on by the user's mouse or pointing device. If a click has not been detected, the process returns to block 320. If a click was detected, the click is further evaluated at block 332.

At block 332, if the click was not detected on one of the activatable elements 604b-604e, whose web page is presently not displayed in the display area 603 of the master web page 600′, the process returns to block 320. However, if a click was detected on one of the activatable elements 604b-604e, whose web page is presently not displayed in the display area 603 of the master web page 600′, the process moves to: i. the optional step of block 334 where an entry is added to the click log 206 of the advertiser for the clicked activatable element 604b-604e, and then to block 336, or ii) directly to block 336.

At block 336, the master web page is revised to reflect the click on the non-displayed activatable element. The web page corresponding to the selected activatable element is moved into the display area of the master web page. The selected activatable element is then highlighted and merged into the display area 603. Contemporaneously, the previous web page is moved out of the display area and returns to functioning as an activatable element.

For example, as shown in FIG. 6B, the click, represented by arrow 682 is on activatable element 604b, whose corresponding web page is presently not displayed in the display area 603 of the master web page 600′, with the listing “Airfare From $39.” This activatable element 604b, now activated, corresponds to the web page for Northern Air Lines, www.northernair.com. Upon this activation, the home server 30 automatically accesses the web site for Northern Air Lines from the server hosting the Northern Air Lines web site, for example, one of the third party servers (TPS1-TPSn) 50a-50n or advertiser Servers (A1-An) 80a-80n, automatically pulls a web page or pages, and automatically places this web page(s) of Northern Air Lines 684 into the display area 603 of the master web page 600′, as the now operable current web site. The activatable element 604b is highlighted and merged (automatically, via the click 682′) into the display area 603 of the master web page 600′, as shown in FIG. 6C. Also, as shown in FIG. 6C, the web page for Metafares has now been removed, also automatically, and the element 604a for the Metafares web page returns to functioning as an activatable element 604a.

In another optional process at block 338, where advertisers are listed and their web pages are associated with the display area 603 and elements 604a-604e of the master web page 600′, the advertiser whose web page is now displayed, e.g., Northern Air Lines, has their account debited by an amount. The process then returns to block 320, from where it continues, as detailed above.

Turning now to blocks 318 and 338, the process of debiting the advertiser's account is shown in detail, in FIG. 3C. The initial inquiry is whether there will be a discount or a premium for the requisite web page display or navigation click, at block 352. If there is not discounting or premiums for the click, or alternately, if there is, but this click will not be discounted or provided a premium, for example, in accordance with a rule or policy, the process moves to block 354, At block 354, the advertiser's account is debited by the advertiser's bid amount (for example, in block 318, Metafares Account is debited by $0.90, the bid amount, and in block 338 Northern Air Lines' account is debited by $0.80, the bid amount), and the process returns to block 320, from where it continues, as detailed above.

If there is discounting or premium placement on the click, the discount or premium is calculated by algorithms that utilize the various data accumulated in the performance logs 32d, as represented by the database of FIG. 2C (where “[DATA]” represents the clicks logged and information associated therewith). In these performance logs 32d, a conversion, for example, is defined as a user purchasing or making a further contact with the advertiser web site, such as an additional request for information, providing his e-mail address for placement on a mailing list, etc. The conversion data 208 is typically a heavily weighted factor by the discounting/premium algorithm.

Additionally, algorithms may also be employed to discount or place premiums on positions for the activatable elements 604a-604e of a master web page 600′. For example, activatable elements 604a, and 604b may have premiums, above the bid amount, based on their left positioning, the center element 604c may be the bid amount, absent any discount or premium, due to its central positioning, while the right elements 604d, 604e, may be discounted, due to their right positioning. The amounts of the discounts or premiums can be determined by utilizing the data from the performance logs 32d, for example, the premiums or discounts may be based on historical conversion data from the particular positions.

The discounting/premium/no additional charge algorithms of the discounting/premium module 34d, incorporate fraud detection technology and procedures, such as those described in commonly owned U.S. patent application Ser. No. 11/844,983, to ensure that the web site owner (advertiser, information provider, etc.) is not charged where there is reason to believe the click did not arise from a bona-fide source, user or consumer. For example, where the click to the same web site originates from the same Internet Protocol (IP) address within too short a span of time, the advertiser is not charged for subsequent clicks from the IP address.

The price an advertiser is charged for each click may also vary, depending upon the value of the click delivered. Click value is determined by statistics taken from historical data, including conversion data for advertisers for traffic on the same or similar web sites. To determine a conversion, it is standard industry practice to render a pixel on a web page that confirms the conversion occurred. The method of tracking user or consumer behavior, detailed in commonly owned U.S. patent application Ser. No. 11/844,983 is usable as a proxy for conversion, where a tracking pixel is not available or the data set is not sufficiently large.

If there is a discount or premium, it is determined by the discounting premium module 34d of the home server 30, at block 356. The advertiser's account is debited by this determined amount, at block 358, and the process returns to block 320, where it resumes as detailed above.

Further, the price charged to an advertiser may vary depending upon the number of other advertisers visited by the user (consumer), through clicking on various advertiser web sites available as activatable elements 604a-604e in the navigation bar 602 of the master web page 600′. In short, the discounting/premium module 34d of the system 20 applies algorithms to adjust the price charged to each advertiser, to ensure that the price is commensurate with the value of the consumer click delivered to the advertiser by the home server 30 of the system 20.

The above-described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer-usable storage media, including magnetic, optical, or semiconductor storage, or other source of electronic signals.

The processes (methods) and systems, including components and steps thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

What is claimed is:

1. A method for providing search results over a communications network to a computer of a user, the computer linked to the communications network, comprising:
receiving, by a system computer device linked to the communications network, a query from a source computer device linked to the communications network, the source computer device in electronic communication with a browsing application of the computer of the user; and
providing a plurality of results in response to receiving the query in a display, by the system computer device, to the browsing application, a first portion of the display for accommodating one result as an operable web site, and, a second portion of the display for accommodating at least one other result as a representation of a web site.

2. The method of claim 1, wherein the operable web site includes a first web site corresponding to a first result and the web site of the representation includes a second web site corresponding to the second result.

3. The method of claim 1, wherein the display includes a master web page sent to the browsing application by the system computer device.

4. The method of claim 3, wherein the master web page includes a plurality of activatable elements, a first activatable element defining a representation of the first web site, and a second activatable element defining the representation of the second web site, the method further comprising: activating the second activatable element, the activation causing the corresponding second web site to be accessed and to replace the first web site in the first portion of the master web page as the operable web site, and, the activation closing the first web site as the operable web site.

5. The method of claim 1, wherein providing the plurality of results is performed automatically upon system computer device receiving the query.

6. The method of claim 1, wherein providing the plurality of results includes obtaining a plurality of results by evaluating the query against stored search terms.

7. The method of claim 6, wherein the evaluating includes selecting a stored search term that matches the query or selecting a search term is correlates to the query.

8. The method of claim 6, wherein the plurality of results includes N results associated with the selected stored search term, the N results being the number of results that can be accommodated by a template selected to be built out into the display.

9. The method of claim 1, additionally comprising: ranking the plurality of results in an order, where the first result is the highest ranked result in the order for the N results.

10. The method of claim 9, wherein a first web site corresponding to the highest ranked result is the operable web site, and the web sites corresponding to the subsequently ranked N results are represented as activatable elements, that when activated, the corresponding web site of the activated activatable element will replace the first web site as the operable web site.

11. The method of claim 10, wherein the first web site corresponding to the highest ranked result is initially displayed as the operable web site in the display.

12. A system for providing search results comprising:
a first computer component configured for receiving a query;
a second computer component configured for providing a providing a plurality of results responsive to the query; and
a third computer component configured for providing at least one template for accommodating the plurality of results and building out the template with the results for display in association with the browsing application of the computer of the user associated with the query, the template including a first portion and a second portion, and the template when built out, the first portion accommodates one result as an operable web site, and, the second portion accommodates at least one other result as a representation of a web site including an activatable element, the activatable element when activated will result in the web site corresponding to the activatable element replacing the currently operable web site as the operable web site in the first portion of the display.

13. The system of claim 12, wherein the third computer component is additionally configured to send the built out template to the browsing application of the computer of the user associated with the query.

14. The system of claim 12, additionally comprising:
a fourth computer component configured for evaluating the received query against stored search terms to obtain the plurality of results.

15. The system of claim 14, wherein the fourth component is configured to evaluate the received query against the stored search terms by selecting a stored search term that either matches or correlates to the query.

16. The system of claim 12, additionally comprising:
a ranking module configured for ranking the plurality of results and ordering the plurality of results in accordance with the ranking.

17. The system of claim 16, wherein the ranking module is in electronic communication with the third computer component such that the web site corresponding to the highest ranked result is initially placed into the first portion of the template upon the build out of the template as the operable web site.

18. The system of claim 14, wherein the first computer component, the second computer component, the third computer component, and, the fourth computer component are all associated with a system server, the system server comprising at least one server.

19. The system of claim 16, wherein the first computer component, the second computer component, the third computer component, and, the ranking module are all associated with a system server, the system server comprising at least one server.

20. A computer-usable storage medium having a computer program embodied thereon for causing a suitably programmed system to provide a display of a plurality of results in response to a query from the computer of a user, over a communications network, to the browsing application of the computer of the user, by performing the following steps when such program is executed on the system:
receiving a query from the computer of the user over the communications network, the computer of the user including a browsing application; and
providing a plurality of results in response to receiving the query in a display, to the browsing application over the communications network, a first portion of the display for accommodating one result as an operable web site, and, a second portion of the display for accommodating at least one other result as a representation of a web site, the representation including an activatable element that when activated provides access to the corresponding web site for placement into the first portion of the display.
